(19) United States
(12) Patent Application Publication
(10) Pub. No.: US 2009/0257378 A1
(43) Pub. Date: Oct. 15, 2009

(54) METHOD AND SYSTEM FOR CONTROLLING A REAL-TIME COMMUNICATIONS SERVICE

(75) Inventors: Renaud CUNY, Espoo (FI); Harri HOLMA, Helsinki (FI); Martin KRISTENSSON, Helsinki (FI)

Correspondence Address: DITTHAVONG MORI & STEINER, P.C., 918 Prince St., Alexandria, VA, 22314, US

(73) Assignee: Nokia Corporation, Espoo (FI)

(21) Appl. No.: 12/489,072

(22) Filed: Jun. 22, 2009

Related U.S. Application Data
(63) Continuation of application No. 10/827,535, filed on Apr. 20, 2004, now abandoned.

(30) Foreign Application Priority Data
Dec. 29, 2003 (FI) 20031912

(51) Int. Cl. H04W 40/00; H04W 4/10

(52) U.S. Cl. 370/328; 455/422.1

(57) ABSTRACT

A real-time media session is established between user equipment and a media communication server via a serving access network. According to the Invention, dummy data (e.g. a dummy message) is sent in order to maintain a dedicated channel during the inactive periods of a real-time media session or to trigger an early setup of a dedicated channel in the access network. In this manner, user equipment logged on to a real-time media (e.g. PoC) session are prevented from going to a radio resource idle state, thus avoiding potential long extra delays during real-time media (e.g. PoC) service usage. The invention further allows the sending and receiving user equipment to set up dedicated channels (DCH) already during the start-to-talk procedure of the transmitting user equipment, which in turn potentially reduces end-to-end delays during the conversation.

### FIELD OF THE INVENTION

The present invention relates to real-time communications services in communication systems.

### BACKGROUND OF THE INVENTION

Particularly in the third-generation (3G) mobile communications systems, a public land mobile network (PLMN) infrastructure may be logically divided into core network (CN) 9,10,11,12 and access network (AN) infrastructures 5,6,7,8, as illustrated in FIG. 1. The access network AN may be called a base station subsystem (BSS) 8 for GSM and a radio network subsystem (RNS) or a radio access network (RAN) 5,6,7 for UMTS. In the technical specifications of the third-generation partnership project (3GPP), the core network CN is logically divided into a circuit-switched (CS) domain 9, a packet-switched (PS) domain 10,11 and an IP multimedia subsystem (IMS) 12. The CS domain refers to the set of all the CN entities offering a “CS type of connection” for user traffic as well as to all the entities supporting the related signaling. A “CS type of connection” is a connection for which dedicated network resources are allocated during connection establishment and released during connection release. A “PS type of connection” transports user information using packets so that each packet can be routed independently. An example of the PS domain is GPRS (General Packet Radio Service), and typical entities may include a serving GPRS support node (SGSN) and a gateway GPRS support node (GGSN). The IP multimedia subsystem comprises all CN elements for the provision of multimedia services. The IP multimedia subsystem IMS utilizes the PS domain to transport multimedia signaling and bearer traffic.

Push-to-talk over Cellular (PoC) is an overlay speech service in a mobile cellular network where a connection between two or more parties is established (typically) for a long period but the actual radio channels in the air interface are activated only when somebody is talking. This corresponds to the usage of the traditional radiotelephones where the used radio frequency is agreed between the parties (e.g. military/police radios, LA radios, walkie-talkie type of radios) and whenever somebody wants to talk s/he presses the tangent, which activates the radio transmission on the selected channel. The traditional radiotelephone services are simplex so that only one party (the one who is pressing the tangent) can talk at a time. More specifically, during voice communication with a “push-to-talk, release-to-listen” feature, a call is based on the use of a pressel (PTT, push-to-talk switch): by pressing PTT the user indicates his/her desire to speak, and the user equipment sends a service request to the network. Alternatively, a voice activity detector (VAD) or any suitable means can be used instead of the manual switch. The network either rejects the request or allocates the requested resources on the basis of predetermined criteria, such as the availability of resources, priority of the requesting user, etc. At the same time, a connection is also established to a receiving user, or users in the case of group communication. After the voice connection has been established, the requesting user can talk and the other users can listen. When the user releases PTT or, in the case of traffic inactivity, the event is detected in the network, and the resources may be released and/or the talk item may be granted to another user. Thus, the resources are reserved only for the actual speech transaction or speech item, instead of reserving the resources for a “call”.

Modern cellular networks, especially in the GSM/GPRS/UMTS network evolution, include new packet-mode (e.g. IP) voice and data services. Push-to-talk over Cellular (PoC) service can be provided as a packet-based user-level or application-level service so that the underlying communications system only provides the basic connections (i.e. IP connections) between group communications applications in the user terminals and a group communication service. The PoC communication service can be provided by a communication server system while the client applications reside in the user equipment or terminals. Examples of this approach are disclosed in co-pending U.S. patent application Ser. Nos. 09/835,867; 09/903,871; and 10/160,272; and in WO 02/085051.

With the PoC service, first the connection(s) between the parties is typically established via the packet-switched (PS) mobile network, for example a packet-switched (PS) core network. In practice, this means that a Voice over IP (VoIP) (group or one-to-one) call is set up between the parties. However, as described above, the difference to a conventional phone call is that the radio channel of the subscribers is activated only when somebody needs to talk and released when nobody is talking.

The PoC service is a practical solution for the cases when the parties need to talk relatively rarely but whenever somebody needs to talk, the connection has to be activated fast and easily (e.g. when giving instructions to the members of a hunting team in the forest or to a crane driver at a construction site). Because in this type of applications, the calls are typically long but the voice activity is low, it is essential to release the bearer (e.g. radio channels) when nobody is talking in order to save the radio and network capacity and terminal batteries. On the other hand, the bearer resources should be available with as small a delay as possible when voice activity again starts.

### DISCLOSURE OF THE INVENTION

An object of the invention is to decrease the delay associated with voice transmission in real-time media communication.

The object is achieved by the invention defined in the attached independent claims. Preferred embodiments of the invention are defined in the sub-claims.

An aspect of the invention is a method of controlling a real-time media session, comprising
sending first signaling from first user equipment via a serving access network of the first user equipment to a first media communication server in response to user's action during an established real-time media session,
sending second signaling from the first media communication server towards the first user equipment,
sending third signaling from the first media communication server towards second user equipment,
sending immediately after the first signaling and/or the second signaling and/or the third signaling dummy media traffic from the first media communication server towards the first user equipment, in order to trigger a dedicated-channel setup for the first user equipment and/or the second user equipment in the serving access network of the first user equipment prior to beginning an actual user media stream from the first user equipment.

An aspect of the invention is a method of controlling a real-time media session, comprising
establishing a real-time media session between first user equipment and second user equipment via a serving access network of the first user equipment, via at least a first media communication server, and via a serving access network of the second user equipment,
sending, by the media communication server or a support node in a packet-switched core network during inactive periods of the real-time media session, dummy media towards at least one of the first and second user equipment in order to reset an inactivity timer of a common channel state in the serving access network of the respective user equipment and to thereby prevent the respective user equipment from going to an idle state.

An aspect of the invention is a media communication server for providing real-time media sessions between sets of user equipment located in one or more access networks, wherein
the media communication server is configured to receive first signaling sent by first user equipment via a serving access network of the first user equipment in response to user's action during an real-time media session established between the first user equipment and second user equipment,
the media communication server is configured to send second signaling towards the first user equipment upon receiving said first signaling,
the media communication server is configured to send third signaling towards the second user equipment upon receiving said first signaling,
the media communication server is configured to send immediately after the first, second and/or third signaling dummy media traffic towards the first and/or second user equipment in order to trigger a dedicated-channel setup for the first and/or second user equipment in the respective serving access network prior to beginning an actual user media stream from the first user equipment.

In an embodiment of the invention, a media communication server is configured to send dummy media traffic to first and/or second user equipment only if the session inactivity prior to first signaling exceeds a certain threshold, in order to limit the amount of unnecessary dummy data sent.

An aspect of the invention is a support node for a packet-switched core network, wherein
the support node is configured to establish a real-time media connection between user equipment located in a radio access network, and a media communication server,
the support node is configured to send during inactive periods of the real-time media connection dummy media towards the user equipment in order to reset an inactivity timer of a common channel state in the radio access network and to thereby prevent the respective user equipment from going to an idle state.

An aspect of the invention is user equipment for a communication system, wherein
the user equipment is configured to establish a real-time media session via an access network and a media communication server,
the user equipment is configured to send a first signaling via the access network to the media communication server in response to user's action during the established real-time media session, and
the user equipment is configured to send immediately after the first signaling dummy media traffic to the media communication server in order to trigger a dedicated-channel setup for the user equipment in the access network of the first user equipment prior to beginning an actual user media stream.

In an embodiment of the invention, the user equipment is configured to send dummy media traffic to the media communication server only if the session inactivity time prior to sending the first signaling exceeds a certain threshold, in order to limit the amount of unnecessary dummy data sent.

The invention is based on sending dummy data (e.g. a dummy message) in order to maintain a dedicated channel during the inactive periods of a real-time media session or to trigger an early dedicated-channel setup in an access network. The invention prevents sets of user equipment that are logged on to a real-time media (e.g. PoC) session from going to a radio resource idle state and, therefore, it prevents potential long extra delays during real-time media (e.g. PoC) service usage. The invention further allows sending and receiving user equipment to set up dedicated channels (DCH) already during the start-to-talk procedure of the transmitting user equipment, which in turn potentially reduces end-to-end delays during the conversation.

### BRIEF DESCRIPTION OF THE DRAWINGS

The above and other objects, features and advantages of the present invention will become more apparent in light of the following detailed description in conjunction with the drawings, in which

FIG. 1 illustrates a communications system having a radio access network RAN, CS and PS core networks, and a PoC server,

FIG. 2 is a block diagram illustrating functional blocks of a PoC server according to an example embodiment of the invention,

FIG. 3 is a block diagram illustrating basic blocks of user equipment according to an example embodiment of the invention,

FIG. 4 illustrates the various states of user equipment UE in WCDMA,

FIG. 5 is a signaling diagram illustrating an example of a signaling flow for maintaining an active state of user equipment,

FIG. 6 is a flow diagram illustrating an example of operation of a PoC server or a support node according to an embodiment of the invention,

FIG. 7 is a signaling diagram illustrating an example of a signaling flow for setting up a media communication,

FIG. 8 is a flow diagram illustrating an example of the operation of UE in accordance with the principles of the present invention,

FIG. 9 is a flow diagram illustrating an example of the operation of a PoC server in accordance with the principles of the present invention, and

FIG. 10 is a signaling diagram illustrating an example of a signaling flow for a communication event where a previous speaker stops speaking and a previous recipient starts speaking.

### DETAILED DESCRIPTION

The present invention is applicable to communications systems enabling real-time media sessions between end-users. The real-time data may include real-time audio (e.g. speech), real-time video, or any other real-time data, or a combination thereof, i.e. real-time multimedia.

The present invention is especially applicable to communications systems allowing packet-mode real-time data communication, such as IP packet communication between end users. Thus, the real-time data communication may be carried out between end-user terminals over the Internet, for example.

The present invention offers a significant improvement for packet-mode speech communications. The voice over Internet Protocol (VoIP) enables speech communication over an IP connection. In some embodiments of the invention, the IP voice communication method employed is the Voice over IP (VoIP), but the invention is not limited to this particular method.

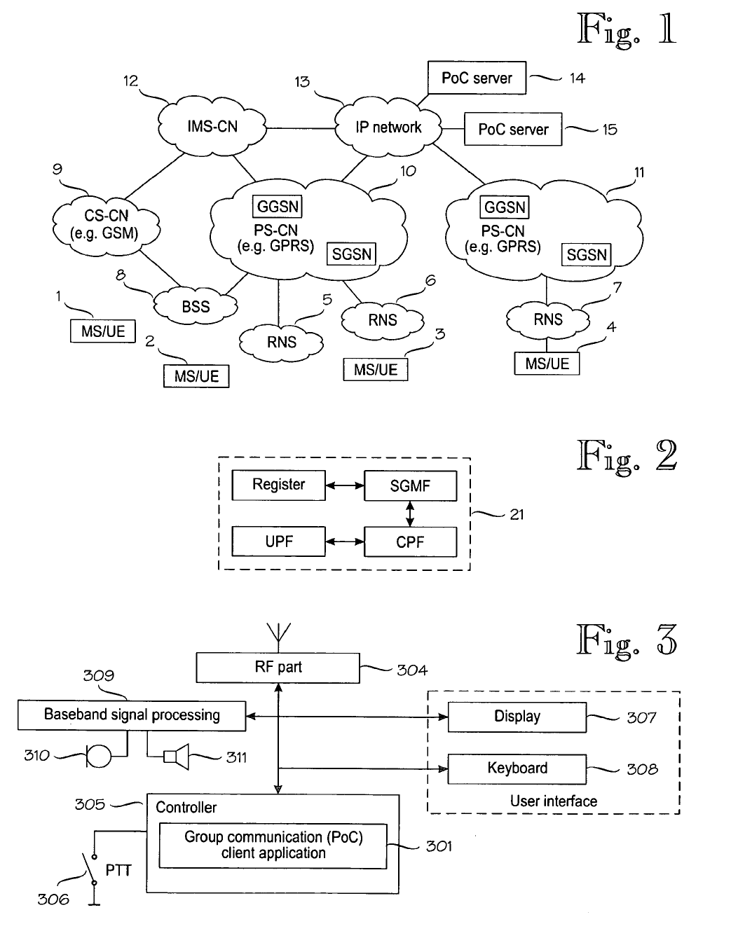

As an example of a system environment, to which the principles of the present invention may be applied, will be described with reference to FIG. 1. In FIG. 1, a Push-to-talk Over Cellular (PoC) server system is provided on top of the Packet-Switched (PS) core network 10, 11, 12 in order to provide a packet-mode (e.g. IP) voice, data and/or multimedia communication services to the User Equipment (UE) 1, 2, 3, 4. UE accessing PS CN, and the PS core network itself, utilizes the services provided by the Radio network subsystem (RNS) or Radio access network (RAN) 5, 6, 7, 8 to provide packet-mode communication between UE and the PS CN subsystem. The multiple access method employed in the air interface in RAN may be Time Division Multiple Access (TDMA), Frequency Division Multiple Access (FDMA), Code Division Multiple Access (CDMA), or a combination thereof. In the third- and higher-generation mobile communications systems, the access method is primarily based on CDMA. Further, because the traffic channels may have a wide bandwidth, corresponding to user data rates, for example up to 2 Mbits/s, such access may also to be referred as Wideband CDMA (WCDMA).

As regards the PoC type services, examples of this concept are disclosed in co-pending U.S. patent application Ser. Nos. 09/835,867; 09/903,871; 10/160,272; and in WO 02/085051. Conceptually, a packet-based media communications system is provided on top of the mobile network in order to provide media communications services to the user equipment UE through the communications system. The media communications system may be embodied as a server system, and it is generally referred to as a media communications server herein. There may be a plurality of media communications servers 14, 15. As illustrated in the example configuration of FIG. 2, the media communications server may comprise control-plane functions CPF and user-plane functions UPF providing packet-mode server applications that communicate with the communication client application(s) in the user equipment UE over the IP connections provided by the communications system. This communication includes signaling packets and voice or data communication packets. The CPF function is responsible for the control-plane management of the group communication. This may include, for example, managing the user activity and creation and deletion of logical user-plane connections with an appropriate control protocol, such as Session Initiation Protocol (SIP). The user-plane function(s) UPF is responsible for the distribution of the data or speech packets to the user terminals according to their group memberships and other settings. UPF forwards traffic only between valid connections programmed by CPF. Speech communication may be based on the voice over IP (VoIP) protocol, and/or Real-time Transport Protocol (RTP). It should be appreciated that the user-plane operation relating to the data or speech traffic is not relevant to the present invention. However, the basic operation typically includes that all the data or speech packet traffic from a sending user is routed to UPF which then delivers the packet traffic to the receiving user(s). The PoC server may include further entities, such as a register and a subscriber and group management function SGMF.

User equipment UE may be a wireless device, such as mobile user equipment, or it may be a device connected by a fixed connection, such as a dispatcher station. Herein the term user equipment and the corresponding acronym UE is used to refer to any device or user equipment allowing the user to access network services.

As an exemplary embodiment, the user equipment UE, such as a Mobile Station MS, may have a PoC application on a user layer on top of the standard protocol stack used in the specific mobile communications system. An appropriate session control protocol, such as Session Initiation Protocol (SIP), may be used for the PoC control-plane signaling. The voice communication may be based on IP communication (such as voice over IP, VoIP), and RTP (Real-time Transport Protocol, defined in RFC1889) may be employed to handle the voice packet (VoIP) delivery on the user plane. The SIP and RTP protocols employ the underlying Transmission Control Protocol (TCP), User Datagram Protocol (UDP) and IP protocols that further employ the physical layer resources, such as the radio resources. For example, the underlying connection in a mobile communications network may be based on a GPRS connection.

An example of a possible implementation of user equipment is illustrated in a simplified block diagram shown in FIG. 3. An RF part 304 represents any radio frequency function and hardware required by the specific air interface employed. The actual implementation of the RF part 304 is not relevant to the present invention. Baseband signal processing 309 represents any baseband signal processing required in any specific implementation, such as an analog-digital (AID) conversion of the analogue speech signal from the microphone 310, vo-encoding, IP packet building, frame building, deframing, IP packet debuilding, vo-decoding, a digital-analog (D/A) conversion of the received digital speech signal into an analog signal applied to a loudspeaker 311. A controller 305 controls the operation of the RF unit 304 and the baseband signal-processing unit 309. The controller 305 controls the signaling, both outband (SIP) and embedded, as well as IP packet building and debuilding. The start and stop of the speech items are set by the PTT switch 306 which can be replaced by any user-operated device, such as a voice activity detector (VAD). Such alternative mechanisms for starting and ending a speech item instead of PTT are obvious to a person skilled in the art. A user interface may include a display 307 and a keyboard 308. It should be appreciated that the blocks illustrated in FIG. 3 are functional blocks that can be implemented in a variety of different circuit configurations. For example, the baseband processing and the controller may be implemented in a single programmable unit (e.g. a CPU or a signal processor) or in a plurality of units. The operation according to the present invention is primarily related to the controller part of MS, and the basic invention may be implemented as program modifications to the control program of MS, for example. It should also be appreciated that the present invention is not intended to be restricted to mobile stations and mobile systems but the terminal can be any terminal having a speech communication capability. For example, the user terminal may be a terminal (such as a personal computer PC) having Internet access and VoIP capability for voice communication over the Internet.

In the embodiment of FIG. 3, the controller 305 comprises a media communication client application 301 (e.g. PoC client). The media communication client application 301 (e.g. PoC client) provides the respective communication service. For example, in case of PoC group communication, the client application 301 may maintain group information, such as group identification information and group membership information. The communication client 301 may also provide tools for group creation, for attaching to (joining) a group and for detaching from (leaving) the group, starting and ending the speech items, etc.

In PS core networks based on GPRS or the like, UE a) performs a GPRS attach procedure, and b) establishes a PDP context (i.e. a bearer) used for SIP signaling. This PDP context will remain active throughout the period UE is connected to PS CN, i.e. from the initial registration and at least until deregistration. As a result, the PDP context provides UE with information that enables UE to construct an IP address. During the establishment of a session, UE establishes data stream(s) for media related to the session. Such data stream(s) may result in the activation of an additional PDP context(s), i.e. bearer(s). Such an additional PDP context(s) is established as a secondary PDP context associated with the PDP context used for signaling. In other core network environments, bearers of other type may be used. It should be appreciated that the basic invention is basically independent of the type of core network.

It should be appreciated that there are many applications of the Internet world that require the creation and management of a session, where a session is considered an exchange of data between a group of participants. The implementation of these applications is complicated by the practices of the participants: users may move between endpoints, they may be addressable by multiple names, and they may communicate in several different media—sometimes simultaneously. Therefore, the present invention is not restricted to PoC services but can be applied to the media flow management of such other applications as well.

Numerous protocols have been authored that carry various forms of real-time multimedia session data, such as voice, video, or text messages. The Session Initiation Protocol (SIP, RFC 3261) is a general-purpose tool for creating, modifying, and terminating sessions that works independently of underlying transport protocols and without dependency on the type of session that is being established. SIP can be used with other IETF protocols to build up a complete multimedia architecture. Typically, these architectures will include protocols such as the Real-time Transport Protocol (RTP) (RFC 1889) for transporting real-time data and providing QoS feedback, the Real-Time streaming protocol (RTSP) (RFC 2326) for controlling the delivery of streaming media, the Media Gateway Control Protocol (MEGACO) (RFC 3015) for controlling gateways to the Public Switched Telephone Network (PSTN), and the Session Description Protocol (SDP) (RFC 2327) for describing multimedia sessions.

It should be appreciated that VoIP and PoC are only examples of real-time media which the present invention can be applied to. It should also be appreciated that the type of media session set up on the application level or the protocols used for controlling the media session on that level are not relevant to the basic invention. The present invention primarily relates to controlling the access bearers on the access-network level, e.g. radio access bearers in RAN.

In the following, a few example embodiments of the present invention will be described using 3GPP RAN (WCDMA) as an example of the access network.

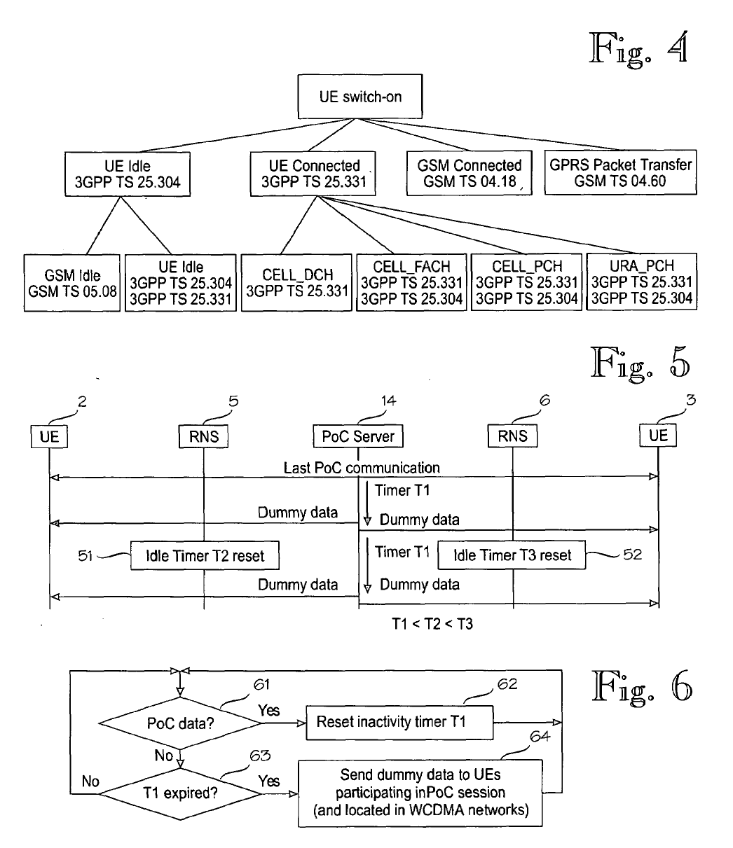

In the 3GPP radio access environment, the user equipment may assume various protocol states. FIG. 4 summarizes the mapping of the UE states, including the states in GSM, to the appropriate 3GPP and GSM specifications that specify UE behavior. These specifications are incorporated herein by reference. However, only UE connected state, CELL_DCH, CELL_FACH, and CELL_PCH are of interest in the following example embodiments of the invention.

After power on, UE stays in Idle Mode until it transmits a request to establish an RRC (Radio Resource Control) Connection. In Idle Mode the connection of UE is closed on all layers of the access stratum. In Idle Mode UE is identified by non-access stratum identities, such as an International mobile subscriber identity (IMSI), Temporary mobile subscriber identity (TMSI) and Packet TMSI (P-TMSI). In addition, RNS has no information of its own on the individual Idle Mode UEs, and it can only address all UEs in a cell or all UEs monitoring a paging occasion.

The RRC Connected Mode is entered when the RRC Connection is, established. UE is assigned a radio network temporary identity (RNTI) to be used as UE identity on common transport channels. The transition to the RRC Connected Mode from the Idle Mode can only be initiated by UE by transmitting a request for an RRC Connection. The event is triggered either by a paging request from the network or by a request from higher layers in UE.

When UE receives a message from the network that confirms the RRC connection establishment, UE enters the CELL_FACH or CELL_DCH state of RRC Connected Mode. The RRC states within RRC Connected Mode reflect the level of UE connection and the transport channels that can be used by UE.

In the CELL_DCH state, a dedicated physical channel is allocated to UE in uplink and downlink, UE is known on cell level according to its current active set, and dedicated transport channels, downlink and uplink shared transport channels, and a combination of these transport channels may be used by UE.

The CELL_DCH-state is entered from Idle Mode through the setup of an RRC connection, or by establishing a dedicated physical channel from the CELL_FACH state. Transition to CELL_FACH state occurs when all dedicated channels have been released, which may be via explicit signaling (e.g. PHYSICAL CHANNEL RECONFIGURATION, Radio Bearer Reconfiguration, Radio Bearer Release, Radio Bearer Setup, Transport Channel Reconfiguration, etc.), or at the end of the time period for which the dedicated channel was allocated.

A transition from CELL_DCH-state to CELL_FACH state may occur after a predetermined period of inactivity. The period is monitored by means of an inactivity timer or timers. The period can be set to any value, typical value being 5 to 10 seconds.

In CELL_FACH state, no dedicated physical channel is allocated to UE and UE continuously monitors FACH in the downlink. RAN may know the position of UE on cell level, i.e. according to the cell where UE last made a cell update.

A transition from CELL_FACH to CELL_DCH state occurs, when a dedicated physical channel is established via explicit signaling (e.g. PHYSICAL CHANNEL RECONFIGURATION, RADIO BEARER RECONFIGURATION, RADIO BEARER RELEASE, RADIO BEARER SETUP, TRANSPORT CHANNEL RECONFIGURATION)

A transition from CELL-FACH state may occur after a predetermined period of inactivity. The period is monitored by means of an inactivity timer or timers. The period can be set to any value, a typical value being 5 to 10 seconds.

In CELL_PCH state, no dedicated physical channel is allocated to UE. UE selects one PCH (Paging Channel) with a suitable algorithm, and uses discontinuous reception (DRX) for monitoring the selected PCH. Thus, the power consumption in UE will be reduced. No uplink activity is possible. The position of UE is known by UTRAN on cell level according to the cell where UE last made a cell update in CELL_FACH state. A transition from CELL_PCH state into Idle mode may occur after a predetermined period of inactivity. The period is monitored by means of an inactivity timer or timers. The period can be set to any value, a typical value being relatively long, for instance 20 to 40 minutes.

Push-to-talk over Cellular (PoC) is a speech service in a mobile network where a connection between two or more parties is (typically) established for a long period but the actual radio channels in the air interface are activated only when somebody is talking. With the PoC service, the connections between the parties are typically established via a packet-switched mobile network. In practice this means that a Voice over IP (VoIP) (group) call is set up between the parties. However, the difference to a conventional phone call is that the radio channel of the subscribers is activated only when somebody needs to talk and released when nobody is talking. In more general terms, there is a streaming-type real-time media signal having a session of long duration but requiring dedicated access resources (e.g. DCH) only occasionally with fast set-up times. There is a need for a method and means for controlling the activating and releasing of the access bearer so that the fast set-up time is achieved.

As noted above, UE that does not transmit or receive any data (i.e. is inactive) will after some time go to radio resource control (RRC) Idle state. The operator can configure the timer controlling the inactivity of UE in RNC, the default inactivity threshold being normally in the order of dozens of minutes, for instance 30 minutes. The inactivity detection function of RNS (e.g. RNC) may also be based on some other criteria, such as traffic volume control, traffic measurement, RLC buffers, timers, etc. UE that is in idle state will need more time to set-up a new data connection. This is because the set up procedure involves more signaling (e.g. RRC). The time needed to go from idle state to active state (CELL_PCH) is more than five seconds, and to CELL_DCH typically more than 10 seconds.

The five-second setup time to go from Idle state to CELL_PCH is not an issue for end-users using data services such as FTP, web browsing, MMS, etc. This is mainly because these services can tolerate some extra delays if they are rare enough. However, for a PoC user that is logged on to a PoC session, five extra seconds of start-to-talk time or delay as compared with the other RRC states is definitely too much. The start-to-talk delay may be defined as the time after the PTT button is pressed until the start-to-speak indication is given to the user (the user can start speaking). According to performed PoC service usability studies, a start-to-speak delay of 4 to 5 seconds is still experienced as annoying. A delay of 1 second or less would not be noticed at all. A delay less than 3 seconds can be considered of a reasonable quality. Thus, there is a need to reduce the communication setup delays.

Referring now to FIGS. 5 and 6, an example of a first aspect of the present invention will be described. An inactivity timer T1 is provided in a media communication (e.g. PoC) server for an ongoing real-time media (e.g. PoC) session. Each time an activity (e.g. PoC data) is detected in the session (step 61 in FIG. 6), the inactivity timer T1 is reset (step 62). If no activity has been noticed in a session for a predefined time T1 (step 63), then the server 14 will send dummy traffic (e.g. data or message) to all UEs 2, 3 that belong to this session (step 64). The dummy traffic, when received in the radio access network RNS 5, 6, will reset (steps 51, 52 in FIG. 5) the inactivity or idle timer(s) T2,T3 controlling the transition from CELL_PCH state (in more general terms, from a common channel state) to Idle state. As a result, the UEs 2, 3 that are logged on to real-time (e.g. PoC) sessions are prevented from going into Idle state and can always be kept in active states. There are several advantages in this solution. Firstly, no (parameter) change is needed in the (e.g. WCDMA) radio networks. For example, the idle timer T2, T3 can be configured as default. The amount of sent dummy data is small because UE typically goes to Idle state after a relatively long period T2, T3 (e.g. 30 minutes) of inactivity. Therefore, the real-time media (e.g. PoC) server can send dummy packets at relatively long intervals T1<T2, T3, for instance every 25 minutes, if no activity has been detected in one session. UE that disconnects from a real-time (e.g. PoC) session will not receive dummy packets and, therefore, may go to Idle state as normally if it is inactive long enough. Dummy packets may also be sent from the server to UEs that are not using the access network (e.g. WCDMA radio networks) that do not contain the idle timer (e.g. GPRS-GSM or WLAN or LAN). In such cases this method does not improve the performance at all. However, it does not decrease the end-to-end service performance either, since these dummy packets will not affect end-to-end services.

In an embodiment of the invention, the above issue is overcome such that the UEs that are in access networks (e.g. WCDMA) notify the server (e.g. by sending their dummy packets or any other packet) that they need to receive dummy data in order to keep them in active state. As a consequence, the server knows to which UE it should send dummy packets. Any system performance degradation in GPRS networks, for instance, is avoided. For example, in FIG. 1, if all UEs 1,2,3,4 are logged in a PoC session, all except UE1 that is located in the BSS/GSM access network would receive dummy data from the PoC server.

According to an embodiment of the present invention, a support node in a packet-switched core network 10,11 that provides a real-time media connection to user equipment UE is configured to send during inactive periods of the real-time media connection dummy media towards the user equipment in order to reset an inactivity timer of a common channel state in the radio access network and to thereby prevent the respective user equipment from going to Idle state. In other words, the functionality described above regarding the PoC server (FIGS. 5 and 6) is implemented in the support node. When the packet-switched core network is a GPRS (General Packet Radio Service) type core network, the support node comprises a serving GPRS service node or a gateway GPRS service node. SGSN or GGSN can determine that a flow accessing a certain Access Point will benefit from receiving from time to time some dummy data in order to wake the UE(s) up. SGSN also knows which radio access technology the UE is using and can, therefore, send dummy data for example to WCDMA terminals only but will not send dummy data to UEs located in GSM BSS.

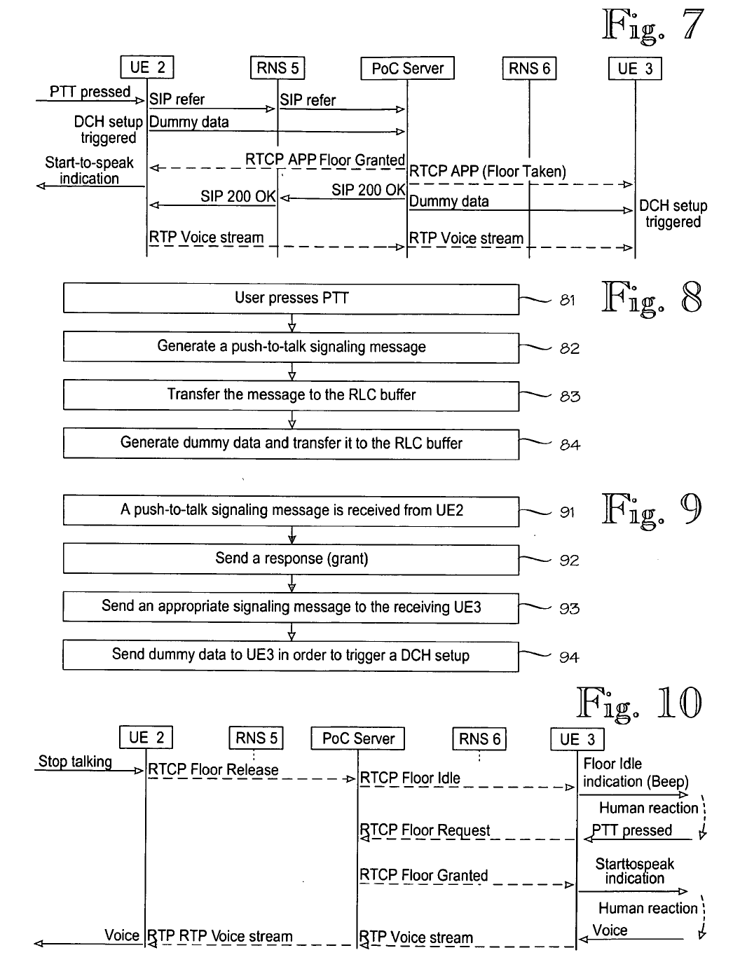

Referring now to FIGS. 7 and 8, examples of a second aspect of the present invention will be described.

As noted above, the communication setup delays are very critical performance indicators of the PoC service and other corresponding real-time media communication. DCH (dedicated radio channel) will need to be established for the PoC service at least for carrying voice data traffic. DCH establishment delays are around 1 second from the active states. The DCH establishment delays can be quite annoying during a PoC conversation especially because DCH delays are counted for each UE so the total end-to-end delay is up to 2*DCH setup time.

It should be appreciated that UE that is in cell_PCH state, for instance, will not go to cell_DCH (i.e. establish DCH) when it has data to send. UE measures the amount of data to be transmitted in the transmission buffer in UE and reports the buffer status to the radio network controller RNC in RNS in order to assist in dynamic radio bearer control. The measurement parameters can be set by RNC. Measurement reports can be triggered using two different mechanisms, periodical and event triggered. The reporting criteria are specified in the measurement control message and may include one or more of Buffer Occupancy, Average of Buffer Occupancy, and Variance of Buffer Occupancy. UE performs measurements and transmit measurement reports according to the measurement control information. For uplink data transmission, UE reports the observed traffic volume to the network in order for the network to re-evaluate the current allocation of resources. This report contains for example the amount of data to be transmitted or the buffer status in UE. The traffic volume or the buffer status depends on the activity of higher-layer functions in UE. For example, in the PoC service, the operation of a speech codec in UE may be such that when a voice activity detector (VAD) indicates silence (and/or the user does not press the tangent), the speech codec does not provide any data to the access network (e.g. to the RLC buffer) in UE, not even silence indicator frames, which are generated during a conventional voice connection supporting discontinuous transmission (DTX).

When the UE user wants to say something to the other member(s) in the PoC call, s/he presses the tangent in UE. The tangent button activates the speech codec regardless of the voice activity and the speech codec starts to generate data into the RLC buffer in UE. When UE is in a common channel state (e.g. CELL_FACH), it reports the event to RNC, which activates the transition to CELL_DCH state.

RNC allocates the required capacity (including DCH), detects a need to change the RLC parameters, carries out a radio link setup procedure with a base station BS, and commands UE to CELL_DCH state.

Similarly, RNC may detect a capacity need in the downlink direction (e.g. based on traffic volume measurements, the downlink buffer status) and activate the transition to CELL_DCH state.

The amount of data sent by UE needs to be large enough (128 bytes by default) and, therefore, signaling messages sent during the start-to- talk procedure may not be big enough to trigger DCH. These messages may instead be sent over RACH and FACH. The amount of data needed to trigger DCH is configurable but again optimal values can not be selected according to one service only in the radio access network RNS.

Thus, according to another aspect of the present invention, a media communications server (e.g. the PoC server), and possibly sending UE, is forced to send enough data so that the set-up of DCH is triggered during the start-to-talk procedure. This dummy data is preferably sent immediately after sending the actual signaling message relating to the initiated start-to-talk procedure. As noted above, signaling in the PoC environment comprises Session Initiation Protocol (SIP) messages and Real-time Transport Control Protocol (RTCP) messages. Messages typically related to the start-to-speak situation include SIP REFER Request, SIP INVITE Request, RTCP Floor Request, and RTCP Floor Taken message.

Compressed SIP signaling messages are slightly over 200 bytes in size whereas RTCP Floor Granted/Taken/Request messages are less than 100 bytes. In an embodiment of the invention, the amount of dummy data sent immediately after sending the signaling message (e.g. SIP REFER or RTCP FLOOR REQUEST or RTCP FLOOR TAKEN) is such that the total amount of data (signaling message+dummy data) is large enough to trigger DCH for the sending UE and/or the receiving UE(s). As a consequence, the amount of dummy data can be quite small: tens of bytes in case of a sent SIP message and around 150 bytes in case of an RTCP message. The aim of the invention is thus achieved with the minimum sent overhead data, and the capacity of the system is not wasted due to the invention.

FIG. 7 shows a signaling diagram illustrating an example of starting a real-time media transaction, (e.g. a PoC speech), in accordance with an embodiment of the present invention. FIG. 8 illustrates an example of the operation of UE in accordance with the principles of the present invention. FIG. 9 illustrates an example of the operation of a PoC server in accordance with the principles of the present invention.

Let us assume that the user equipment UE2 is initially in CELL_FACH state or CELL_PCH state. When the user of UE2 wants to say something to the other member(s) in the PoC session, s/he presses the pressel PTT 306 in UE. The PoC application 301 in the controller 305 detects that the pressel PTT is pressed (step 81 in FIG. 8), and generates a SIP REFER message (or SIP INVITE) and transfers it to the RLC transmit buffer in UE2 (steps 82 and 83). Further, in accordance with an embodiment of the invention, the PoC application (or e.g. the speech codec) also generates dummy data which is also transferred to the RLC buffer in UE2 (step 84). The amount of the dummy data is such that the total data level in the RLC buffer will exceed the DCH threshold (e.g. 200 bytes). As a result, UE2 will initiate an RRC procedure to setup a Dedicated Channel (DCH), i.e. UE2 sends a capacity request (e.g. an RRC MEASUREMENT REPORT message) to RNC, which activates DCH for the PoC session. Now UE2 is able to send the content of the RLC buffer, i.e. the signaling message and the dummy data, over DCH to RNS 5, and further to the PoC Server. Upon receiving the SIP REFER message, and if the turn to speak (a speech item) is granted to UE2, the RNC returns a RTCP Floor Granted message. Upon receiving the RTCP Floor Granted message, UE2 will give a Start-to-speak indication (such as a beep) to the user, and the user starts to speak. The Voice activity detector VAD will detect the speech and start to generate a speech data stream to the RLC buffer. This data can be sent immediately since DCH is already set up. However, the start-to-speak time (time from pressing the pressel to the start-to-speak indication) is prolonged in comparison with the present case, since DCH is setup in between.

In an alternative embodiment of the invention, UE first waits (after the step 83 in FIG. 8) that the signaling message (SIP or RTCP) is fully transmitted over the radio before sending the dummy data that would trigger DCH set-up. Now the amount of dummy data must alone exceed the triggering threshold. In this approach, the sending of the actual start-to-speak message (such as the SIP TRANSFER) and the response (such as the RTCP Floor Granted), and thereby the start-to-speak indication, are not delayed due to the DCH setup. On the other hand, the DCH setup will still be initiated before the user starts to speak. Thus, this approach allows the start-to-speak time to remain below 1 second whereas the conversation delay would be decreased in comparison with the case where the dummy data is not sent.

In still another embodiment, the sending UE2 does not send any dummy data. In such a case, the reduction of the delay will be achieved by the operation of the PoC server towards the receiving side, as will be explained below.

Upon receiving the initial start-to-speak message (such as the SIP TRANSFER) from and having sent the response (such as the RTCP Floor Granted) to UE2 (steps 91 and 92 in FIG. 8), the PoC server will send an appropriate signaling message (such as the RTCP Floor Taken) to UE3 (step 93). In an embodiment of the invention, the PoC server also sends dummy data with or immediately after the actual signaling message (step 94). The amount of data is such that it alone or together with the signaling message exceeds the DCH setup threshold in the serving RNS6 of the receiving UE3. As a consequence, a downlink DCH is setup for UE3 and the signaling message and the dummy data is sent to UE3 over the established DCH. Since DCH is now ready, the subsequent RTP voice stream from UE2 can be sent to UE3 without the DCH setup delay. Thus, the conversation delay will decrease significantly, typically over 1 second (the DCH setup delay of the receiving user).

The inventive operation of the PoC server for the receiving side may be applied alone or in combination with any of the above operations of the sending UE. It should be noted that although the sending UE would not send any dummy data to trigger the DCH setup, the server would still decrease speech round trip time delay by sending to the receiving UE a dummy message immediately after sending the RTCP FLOOR TAKEN message. This server-only solution may in fact be advantageous because it would allow to keep the start-to-speak time under 1 second (DCH establishment delay not counted) whereas the Speech round trip time would decrease significantly.

FIG. 10 shows a signaling flow diagram illustrating an example of another session event to which the principles of the present can be applied. The present speaker, for example the user of UE2, stops speaking. This is indicated by the release of the PTT pressel, for instance. UE2 signals the “stop of talk” event to the PoC server. This signaling may include a RTCP Floor Release, for example. In response to receiving the “stop of talk” signaling, the PoC server indicates the event to the receiving UE3 by means of an appropriate signaling. This signaling may include a RTCP Floor Idle message. UE3 indicates the event (e.g. Floor Idle) to the user by an appropriate indication, such as a beep. After a delay caused by the human reaction, the user presses the PTT pressel. This may cause a similar procedure as described in connection with FIG. 7. The PoC application 301 in the controller 305 detects that the pressel PTT is pressed and generates an appropriate message (such as a RTCP Floor Request ) and transfers it to the RLC transmit buffer in UE3. Further, in accordance with an embodiment of the invention, the PoC application (or e.g. the speech codec) also generates dummy data which is also transferred to the RLC buffer in UE3. The amount of dummy data is such that the total data level in the RLC buffer will exceed the DCH threshold (e.g. 200 bytes). As a result, UE2 will initiate a RRC procedure to setup a Dedicated Channel (DCH), and RNC in RNS6 activates DCH for the PoC session. Now UE3 is able to send the content of the RLC buffer, i.e. the signaling message and the dummy data, over DCH to RNS 6, and further to the PoC Server. Upon receiving the message, and if the turn to speak (a speech item) is granted to UE3, the PoC server returns an appropriate response, such as a RTCP Floor Granted message. Upon receiving the RTCP Floor Granted message, UE3 will give a Start-to-speak indication (such as a beep) to the user, and the user starts to speak after a human reaction time. The Voice activity detector VAD will detect the speech and start to generate a speech data stream to the RLC buffer. Again, the voice data can be sent immediately since DCH is already set up.

Alternatively, as in one of the embodiments described above, UE3 may send the actual message, e.g. RTCP Floor Granted message, first and the dummy data later. Still further, UE3 may send only the actual message, for example RTCP Floor Granted message.

Upon receiving the initial message (such as the RTCP Floor Request) from and having sent the response (such as the RTCP Floor Granted) to UE3, the PoC server will send an appropriate signaling message (such as the RTCP Floor Taken) to UE2. In an embodiment of the invention, the PoC server also sends dummy data with or immediately after the actual signaling message. The amount of data is such that it alone or together with the signaling message exceeds the DCH setup threshold in the serving RNS5 of UE2. As a consequence, a downlink DCH is setup for UE2 and the signaling message and the dummy data are sent to UE2 over the established DCH. Since DCH is now ready, the subsequent RTP voice stream from UE3 can be sent to UE2 without the DCH setup delay.

In all embodiments relating to the second aspect of the invention, the PoC server may selectively send dummy data only to the UEs which are located in appropriate access networks (such as WCDMA), as discussed above relating to the first aspect of the invention.

In all embodiments of the invention, the serving access networks of the sending UE and the receiving UE(s) may be the same one or different ones.

It should be appreciated that all the above operation beyond sending the dummy data for triggering the DCH setup or resetting inactivity timer may basically be implemented in accordance with the 3GPP specifications and existing PoC functionality.

Various embodiments of the invention have been described, but it will be appreciated by persons skilled in the art that these embodiments are merely illustrative and that many other embodiments are possible. The intended scope of the invention is set forth in the following claims, rather than the preceding description, and all variations that fall within the scope and spirit of the claims are intended to be embraced therein.

1. A method of controlling a real-time media session, comprising:
sending first signaling from first user equipment via a serving access network of the first user equipment to a first media communication server in response to a user's action during an established real-time media session;
sending second signaling from the first media communication server towards the first user equipment;
sending third signaling from the first media communication server towards second user equipment; and
sending, immediately after one of the first, the second and the third signaling, dummy media traffic from the first media communication server towards the first and second user equipment, in order to trigger a dedicated-channel setup for at least one of the first and second user equipment in their respective serving access networks prior to beginning an actual user media stream from the first user equipment.

2. The method according to claim 1, comprising:
setting an amount of dummy data, such that the dummy data and the first signaling data together exceed a threshold level for triggering the dedicated-channel setup.

3. The method according to claim 1 comprising:
sending, immediately following the one of the first, the second and the third signaling, dummy media traffic only if a session inactivity time prior to the first signaling exceeds a certain threshold.

4. The method according to claim 1, for a packet-mode voice communication, comprising:
sending said first signaling in response to detecting in the first user equipment activation of a push-to-talk pressel.

5. The method according to claim 1, wherein one of said first and second signaling comprises one of a Session Initiation Protocol (SIP) message, a Real-time Transport Control Protocol (RTCP) message, a SIP REFER Request, a SIP INVITE Request, a RTCP Floor Request, and a RTCP Floor Taken message.

6. The method according to claim 1, wherein the real-time media service is one of a push-to-talk service over cellular and a corresponding packet-mode voice communication service of a client-server type, the real-time media stream is packet-mode speech, and at least one of the serving access networks comprises a radio access network of a wideband code division multiple access type.

7. A method of controlling a real-time media session, comprising:
establishing a real-time media session between first user equipment and second user equipment via a serving access network of the first user equipment, via at least a first media communication server, and via a serving access network of the second user equipment; and
sending, by one of the media communication server and a support node in a packet-switched core network during inactive periods of the real-time media session, dummy media towards at least one of the first and second user equipment in order to reset an inactivity timer of a common channel state in the serving access network of the respective user equipment and to thereby prevent the respective user equipment from going to an idle state.

8. The method according to claim 7, further comprising:
monitoring the media activity of the real-time media session in one of the first media communication server and the support node; and
if no media activity is detected in the real-time media session for a predetermined period of time, sending said dummy media traffic from the one of the first media communication server and the support node towards at least one of the first and second user equipment.

9. The method according to claim 7, comprising sending said dummy media traffic to said at least one of the first and second user equipment only if the respective user equipment is located in an access network in which a dedicated channel setup can be triggered by dummy media traffic.

10. The method according to claim 9, comprising notifying by the respective user equipment that it is located in an access network in which a dedicated channel setup can be triggered by dummy media traffic.

11. The method according to claim 7, wherein the real-time media service is one of a push-to-talk service over cellular and a corresponding packet-mode voice communication service of a client-server type, the real-time media stream is packet-mode speech, and at least one of the serving access networks comprises a radio access network of a wideband code division multiple access type.

12. The method according to claim 7, wherein the packet-switched core network is a GPRS (General Packet Radio Service) type core network, and wherein the support node comprises one of a serving GPRS service node and a gateway GPRS service node.

13. A media communication server for providing real-time media sessions between user equipment located in one or more access networks, wherein:
the media communication server is configured to receive first signaling sent by first user equipment via a serving access network of the first user equipment in response to user's action during an real-time media session established between the first user equipment and second user equipment;
the media communication server is configured to send second signaling towards the first user equipment upon receiving said first signaling;
the media communication server is configured to send third signaling towards the second user equipment upon receiving said first signaling; and
the media communication server is configured to send, immediately following one of the first, second, and third signaling, dummy media traffic towards one of the first and second user equipment in order to trigger a dedicated channel setup for the one of the first and the second user equipment in a respective serving access network prior to beginning an actual user media stream from the first user equipment.

14. The media communication server according to claim 13, wherein one of said first and the second signaling comprises one of a Session Initiation Protocol (SIP) message, a Real-time Transport Control Protocol (RTCP) message, a SIP REFER Request, a SIP INVITE Request, a RTCP Floor Request, and a RTCP Floor Taken message.

15. The media communication server according to claim 13, wherein the media server is arranged to send said dummy media traffic from the first media server to the one of the first and the second user equipment only if these are located in an access network in which a dedicated channel setup can be triggered by dummy media traffic.

16. The media communication server according to claim 13, wherein the real-time media service is one of a push-to-talk service over cellular and a corresponding packet-mode voice communication service of a client-server type, the real-time media stream is packet-mode speech, and at least one of the serving access networks comprises a radio access network of a wideband code division multiple access type.

17. The media communication server according to claim 13, wherein the media communication server is configured to send dummy media traffic to the first and/or second user equipment only if the session inactivity prior to first signaling exceeds a certain threshold, in order to limit the amount of unnecessary dummy data sent.
